(19) United States
(12) Patent Application Publication
(10) Pub. No.: US 2012/0050724 A1
(43) Pub. Date: Mar. 1, 2012

(54) PHASE RETRIEVAL SYSTEM FOR ASSESSING DIAMOND-TURNING AND OTHER OPTICAL SURFACE ARTIFACTS

(76) Inventors: Bruce H. DEAN, New Market, MD (US); Matthew R. Bolar, Laurel, MD (US); Alejandro V. Maldonado, Tucson, AZ (US)

(21) Appl. No.: 12/872,366

(22) Filed: Aug. 31, 2010

(51) Int. Cl. G01B 9/00; G01N 21/00

(52) U.S. Cl. 356/124; 356/239.2

(57) ABSTRACT

A phase retrieval optical metrology system that can be used for evaluating a variety of optical surface errors is provided. The optical metrology system can comprise an optical element defining an optical axis and a focal plane, a fiber coupler coupled to the laser, a fiber connected to the fiber coupler for transmitting light received from the fiber coupler, a collimator for receiving the light received from the fiber and substantially collimating the light to generate a narrowed input light beam, and a defocus element disposed between the optical element and the focal plane.

### STATEMENT OF GOVERNMENT INTEREST

The invention described herein was at least in-part made by an employee of the United States Government and may be manufactured and used by or for the Government of the United States of America for governmental purposes without the payment of any royalties thereon or therefor.

### FIELD

The present invention relates generally to evaluating a variety of optical surface errors, and particularly, surface errors originating from diamond-turning artifacts.

### BACKGROUND

Diamond-turning artifacts are common by-products of optical surface “shaping” using the “diamond-turning” process. Diamond turning is a process of mechanical machining of precision elements using Computer Numerical Control (CNC) lathes equipped with natural or synthetic diamond-tipped cutting elements. The process of diamond turning is widely used to manufacture high-quality aspheric optical elements from crystals, metals, acrylic, and other materials. Optical elements produced by the means of diamond turning can be used in optical assemblies in telescopes, TV, projectors, missile guidance systems, scientific research instruments, and numerous other systems and devices.

Assessing and evaluating errors imparted by a diamond-turning process can be problematic and generally requires an interferometer which can be both in the hardware used and in calibration. What is needed is a simpler optical setup for assessing and evaluating optical surface errors, while simultaneously offering a surface-level assessment of the diamond-turned part at the nanometer level, using only image-based data (data collected by an imaging chip or charge-coupled device (ccd array or other associated imaging arrays)).

### SUMMARY

According to various embodiments of the present teachings, an optical metrology system is provided for assessing and evaluating optical surface errors. This optical metrology system can be used for surface-level assessment of refractive lenses for diamond-turning artifacts, at the nanometer level. In some embodiments, only image-based data is used for assessing the impact of the surface errors.

According to various embodiments, the optical metrology system can comprise an optical element, a laser, a fiber coupler, a fiber connected to the fiber coupler, a collimator, and a defocus element. In some embodiments, the fiber coupler can be coupled to the laser and the fiber can be connected to the fiber coupler. The laser can produce light that is received by the fiber coupler. The fiber coupler can transmit light received from the laser to the fiber. The fiber can transmit light received from the fiber coupler to the collimator. The collimator can receive light transmitted from the fiber and substantially collimate the light to generate a narrowed input light beam.

According to some embodiments, the defocus element can comprise at least one first lens for producing a positive defocus image of a light beam passing through the optical element, and at least one second lens for producing a negative defocus image of the light beam passing through the optical element.

### BRIEF DESCRIPTION OF THE DRAWINGS

The present teachings will be described with reference to the accompanying drawings. The drawings are intended to illustrate, not limit, the present teachings.

FIG. 1 shows a block diagram depicting components of an optical metrology system according to an exemplary embodiment of the present teachings, although alternative implementations and embodiments are also within the scope of the teachings.

FIG. 2 shows a block diagram depicting components of an optical metrology system, including a pupil imaging lens, according to an exemplary embodiment of the present teachings, although alternative implementations and embodiments are also within the scope of the teachings.

FIG. 3 shows a plano-convex design form according to an exemplary embodiment of the present teachings, although alternative implementations and embodiments are also within the scope of the teachings.

FIG. 4 shows a plano-convex design form with an asphere, according to an exemplary embodiment of the present teachings, although alternative implementations and embodiments are also within the scope of the teachings.

FIG. 5 shows a ray trace layout according to an exemplary embodiment of the present teachings, although alternative implementations and embodiments are also within the scope of the teachings.

FIG. 6 shows a table of components for an optical metrology system according to an exemplary embodiment of the present teachings, although alternative implementations and embodiments are also within the scope of the teachings.

FIG. 7 shows a table providing the fiber divergence for various rail positions, according to an exemplary embodiment oldie present teachings, although alternative implementations and embodiments are also within the scope of the teachings.

FIG. 8 shows a numerical aperture plot for an optical metrology system according to an exemplary embodiment of the present teachings, although alternative implementations and embodiments are also within the scope of the teachings.

FIG. 9 shows a table depicting beam diameters associated with various fiber distances achieved according to an exemplary embodiment of the present teachings, although alternative implementations and embodiments are also within the scope of the teachings.

FIG. 10 shows a plot depicting estimated beam diameters associated with various fiber distances based on empirical data, according to an exemplary embodiment of the present teachings, although alternative implementations and embodiments are also within the scope of the teachings.

FIG. 11 shows example phase retrieval (PR) results, according to an exemplary embodiment of the present teachings, although alternative implementations and embodiments are also within the scope of the teachings.

FIGS. 12 and 13 show a comparison between image-based data (FIG. 12) and a Fourier Model resulting from a method according to the present teachings (FIG. 13).

FIG. 14 shows a graph depicting phase retrieval decomposition, according to various embodiments of a method according to an exemplary embodiment of the present teachings, although alternative implementations and embodiments are also within the scope of the teachings.

FIG. 15 shows residual surface structure after removal of low-order Zernikes, according to an exemplary embodiment of the present teachings, although alternative implementations and embodiments are also within the scope of the teachings.

### DETAILED DESCRIPTION

According to various embodiments of the present teachings, an optical metrology system is provided. The optical metrology system can be used for evaluating a variety of optical surface errors and can be Modified to accommodate reflective as well as refractive surfaces. In some embodiments, the surface errors can be imparted by diamond-turning and other optical manufacture techniques.

According to various embodiments of the present teachings, an optical metrology system for assessing impact of optical surface artifacts is provided. The system can comprise: an optical element defining an optical axis and a focal plane; a laser for producing light; a fiber coupler coupled to the laser; a fiber connected to the fiber coupler for transmitting light received from the fiber coupler; a collimator disposed in a beam path between the fiber and the defocus element, the collimator being adapted to receive light transmitted from the fiber and substantially collimate the light to generate a narrowed input light beam: and a defocus element disposed between the optical element and the focal plane. The defocus element can comprise at least one first lens for producing a positive defocus image of a light beam passing through the optical element, and at least one second lens for producing a negative defocus image of the light beam passing through the optical element.

The at least one first lens can comprise a relatively high powered lens and the at least one second lens can comprise a relatively low powered lens, for example, a lens having a lower power than that of the at least one first lens. The at least one second lens can comprise a pupil imaging lens. The at least one first lens can comprise a zinc selenide (ZnSe) lens or a barium fluoride (BaFl) lens. The at least one second lens can comprise a zinc selenide (ZnSe) lens or a barium fluoride (BaFl) lens. The optical element can comprise at least one of a lens, a mirror, an imaging system, a camera, a detector, a laser, and a combination thereof.

In some embodiments, the at least one first lens can comprise at least one of a bi-convex lens, a bi-concave lens, a positive meniscus lens, a negative meniscus lens, a plano-convex lens, and a plano-concave lens. The at least one second lens comprises at least one of a bi-convex lens, a bi-concave lens, a positive meniscus lens, a negative meniscus lens, a plano-convex lens, and a plano-concave lens. In some embodiments. the fiber comprises a numerical aperture (NA) of from about 0.15 to about 0.2, for example, of about 0.12. The laser can comprise a helium neon (HeNe) laser.

According to various embodiments, a method of measuring the numerical aperture of an optical system is provided. The system can be a system as described herein, for example, as described in the many paragraphs immediately above. The method can comprise: aligning the laser with the fiber; aligning the fiber with a rail; setting a first screen position; measuring the diameter of a beam passing through the defocus element; setting a second screen position that is moved back relative to the first screen position; measuring a second diameter of the beam; determining a DZ from the two measurements; determining a Dd from the two measurements; and calculating a numerical aperture based on the DZ and the Dd.

In some embodiments, the first screen position can be at about 30 mm from the defocus element and the second screen position can be at about 40 mm from the defocus element. The system can optionally comprise a collimator disposed in a beam path between the fiber and the defocus element. The collimator can be adapted to receive light transmitted from the fiber and substantially collimate the light to generate a narrowed input light beam.

According to various embodiments, the optical metrology system can comprise an optical element defining an optical axis and a focal plane, a fiber coupler coupled to the laser, a fiber connected to the fiber coupler for transmitting light received from the fiber coupler, a collimator for receiving the light received from the fiber and substantially collimating the light to generate a narrowed input light beam, and a defocus element disposed between the optical element and the focal plane. The defocus element can comprise a support element, a plurality of first lenses associated with the support element for producing positive defocus images of the light beam on the detector, and a plurality of second lenses associated with the support element for producing negative defocus images of the light beam on the detector, irrespective of a position of the plurality of second lenses along the optical axis.

According to some embodiments, the optical metrology system can be used in combination with an image-based sensing technique, such as a wavefront sensing technique or a phase retrieval image-based sensing technique. Phase retrieval can be used to estimate optical imperfections or aberrations, as described, for example, in U.S. Patent Application Publication No. US 2008/0040077 A1, which is incorporated by reference herein in its entirety. Phase retrieval is a subset of image-based wavefront sensing. Image-based wavefront sensing can comprise any of a class of algorithms used to recover optical phase information from measured images of a defocused point source, for example, as described in U.S. Patent Application Publication No. US 2008/0296477 A1. which is incorporated by reference herein in its entirety.

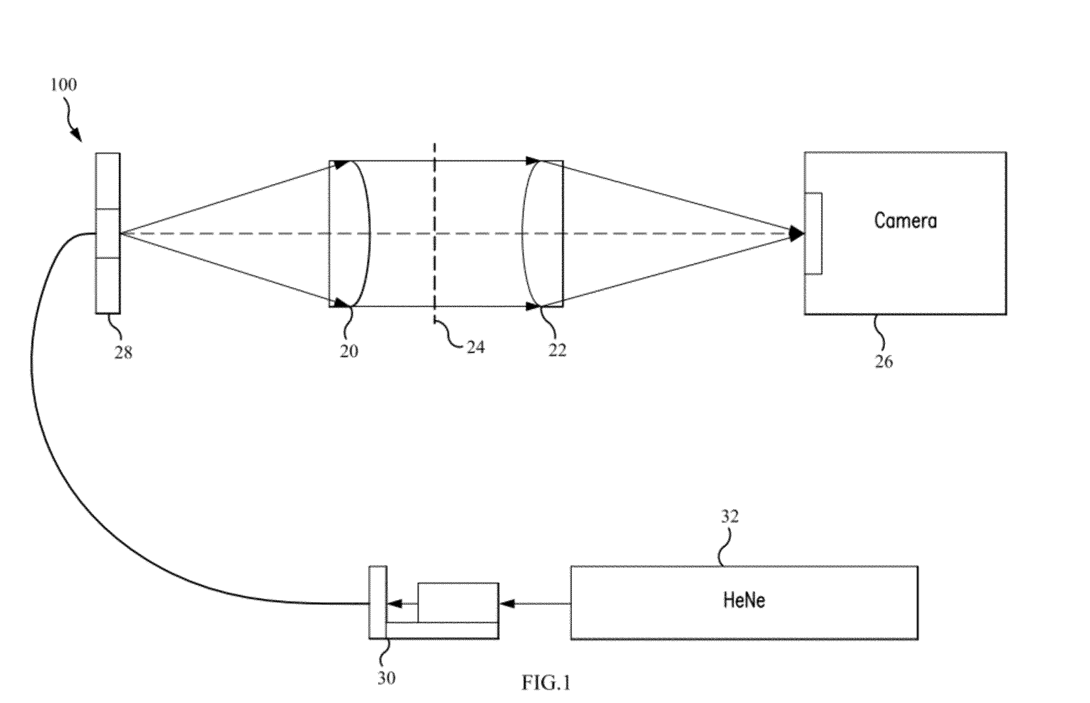

According to various embodiments, and as depicted in FIG. 1, an optical metrology system 100 can comprise an optical element 26 such as a camera, a laser 32, a fiber coupler 30, a fiber 28 connected to the fiber coupler 30, a collimator 20, and a defocus element 22. Fiber coupler 30 can be coupled to laser 32. Fiber 28 can be connected to fiber coupler 30. Laser 32 can produce light that is received by Fiber coupler 30. Fiber coupler 30 can transmit light received from laser 32 to fiber 28. Fiber 28 can transmit light received from fiber coupler 30 to collimator 20. Collimator 20 can receive light transmitted from fiber 28 and substantially collimate the light to generate a narrowed input light beam. The optical element 26 can define an optical axis and a focal plane. According to some embodiments, defocus element 22 can be disposed between optical element 26 and the focal plane. Fiber 28 can have an NA of about 0.12 and course z adjustment or tuning. Defocus element 22 can have an EFL of 10 in and tip/tilt with fine z adjustment or tuning. Fiber coupler 30 can comprise a 10× power and an NA of 0.15.

According to various embodiments, a shear plate 24 can be disposed at a Position that is between collimator 20 and defocus element 22 during collimation, alignment, or both. Collimator 20 can comprise an ACHROMAT lens having an EFL of 250 mm and tip/tilt with fine z adjustment or tuning. The overall length of the system can be about 30 in.

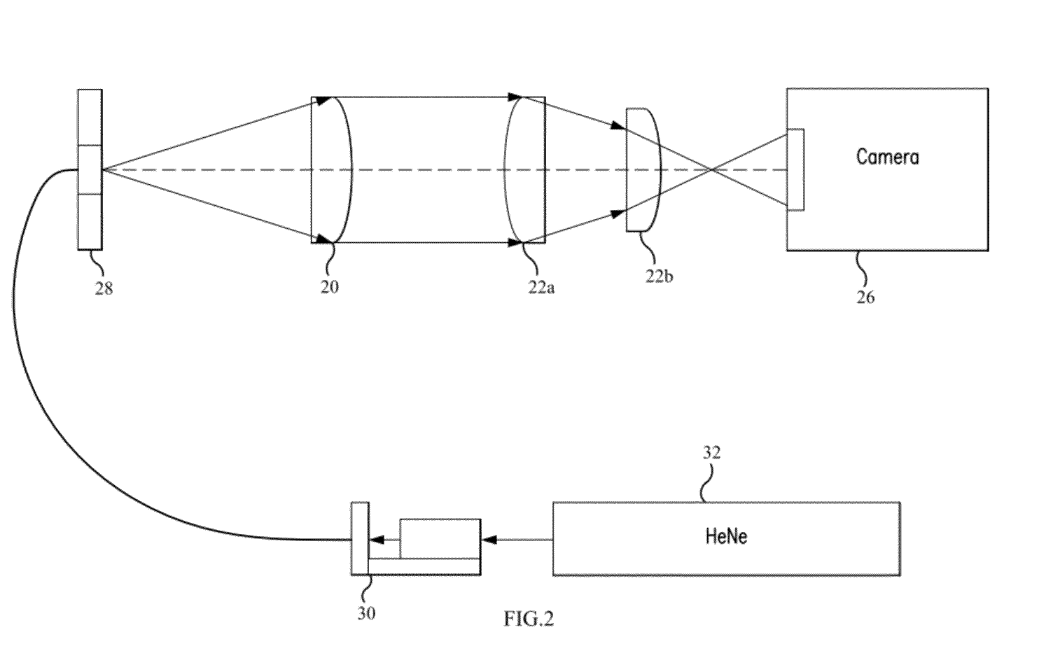

As shown in FIG. 2, according to some embodiments, a defocus element be included that comprises at least one first lens 22a for producing a positive defocus image of a light beam passing through the optical element. First lens 22a can comprise a high powered lens. In some embodiments, the defocus element can comprise at least one second lens 22b or pupil imaging lens for producing a negative defocus image of the light beam passing through the optical element. Second lens 22b can comprise a low powered lens, for example, of a lower magnification than first lens 22a. According to some embodiments, at least one first lens 22a can comprise a Zinc Selenide (ZnSe) lens, a Barium Fluoride (BaFl) lens, a combination thereof, or the like. According to some embodiments, second lens 22b can comprise a Zinc Selenide (ZnSe) lens, a Barium Fluoride (BaFl) lens, a combination thereof, or the like. According to some embodiments, each first lens 22a can comprise at least one of a bi-convex lens, a bi-concave lens, a positive meniscus lens, a negative meniscus lens, a plano-convex lens, and a plano-concave lens.

According to some embodiments, each second lens 22b can comprise at least one of a bi-convex lens, a bi-concave lens, a positive meniscus lens, a negative meniscus lens, a plano-convex lens, and a plano-concave lens. In some embodiments, collimator 20 can comprise an EFL of from about 100 mm to about 600 mm, or from about 200 mm to about 500 mm, for example, of 225 mm, 250 mm, 300 mm, or 350 mm. In the embodiment shown in FIG. 2, fiber 28 can have an NA of about 0.12 and course z adjustment or tuning. Defocus element 22 can have an EFL of 200 mm and tip/tilt with fine z adjustment or tuning. Fiber coupler 30 can comprise a 10× power and an NA of 0.15.

According to various embodiments, optical element 26 in each of FIGS. 1 and 2 can comprise at least one of a lens, a mirror, an imaging system, a camera, a detector, a laser, a prism, a defraction grating, a combination thereof, or the like. According to some embodiments, optical element 26 can be a mono 12-bit camera, for example, as available from Q-IMAGING, for example, the Q-IMAGING 32-0063A-119 mono 12-bit camera with fine z adjustment or tuning.

According to various embodiments, fiber 28 can comprise a numerical aperture (NA) of from about 0.05 to about 0.5, for example, from about 0.1 to about 0.2, or of about 0.11, about 0.12, about 0.13, about 0.14, about 0.15. about 0.16, about 0.17, about 0.18, or about 0.19. According to various embodiments, laser 32 can comprise an HeNe laser or the like.

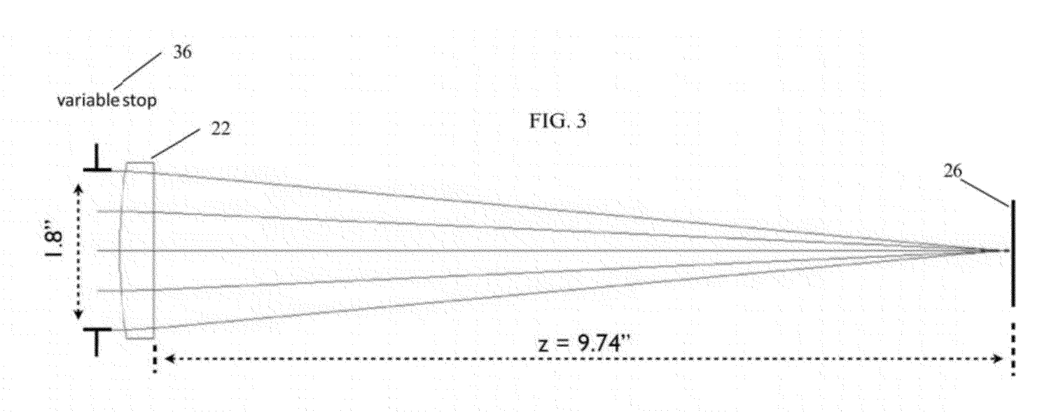

FIG. 3 shows a plano-convex design form that can be used according to an exemplary embodiment of the present teachings. A variable stop 36 can be used with a defocus element 22. In some embodiments, defocus element 22 can be 2 inches in diameter and can form an EFL of 10 in. In use, a merit function can be defined to constrain the EFL to 10 in, for example, by placing a solve on the ROC for the first surface, for example, an ROC of 5.139 in. Then, a marginal ray-angle solve can be placed on z. Here, the defocus is 3.5λ, the spherical is 1.2λ, and the λ is 670 nm.

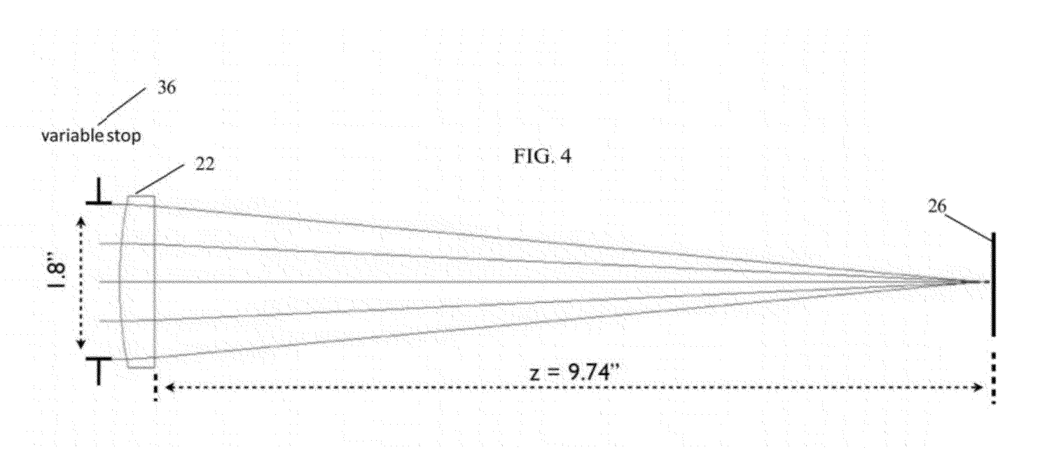

FIG. 4 shows a plano-convex design form with an asphere, according to an exemplary embodiment of the present teachings. A variable stop 36 can be used with a defocus element 22. In some embodiments, defocus element 22 can be 2 inches in diameter and can form an EFL of 10 in. In use, a merit function can be defined to constrain the EFL to 10 in, for example, by placing a solve on the conic for the first surface, for example, a conic of −0.581972 in. Then, a marginal ray-angle solve can be placed on z. Here, the defocus is 1.7 e-4λ, the spherical is 8.5 e-4λ, and the λ is 670 nm.

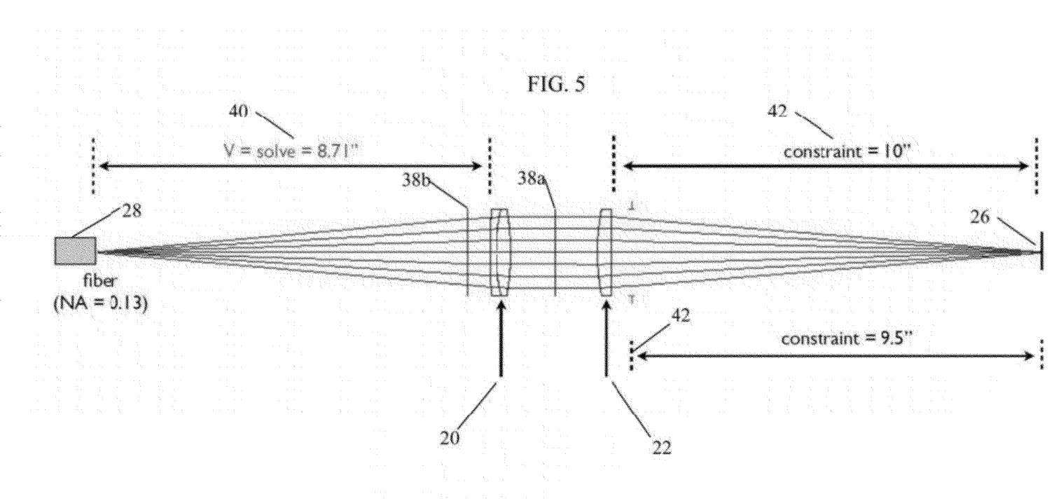

FIG. 5 shows a ray trace layout according to an exemplary embodiment of the present teachings. As shown, lens 20 can comprise a NEWPORT PAC088. A dummy surface 43 can be used between fiber source 28 and lens 38b. A defocus element 22, for example, a ZnSe tester, can be used and a dummy surface 38a can be disposed between lens 20 and defocus element 22. In the system shown in FIG. 5, given the NA of 0.13 as an input, an initial optimization was made for a single variable V. The solution is the arrangement shown in FIG. 5 subject to a first part wherein the overall exit pupil WFE can be minimized, and a second part wherein a collimated beam is provided after a PAC088. In FIG. 5, 42 is shown as the dimension of the 10 inch constraint, 40 is shown as the dimension of the V=solve of 8.71 inches. Also, the focal plane is shown as reference numeral 26.

According to an NA measurement procedure that can be used in accordance with the present teachings, the laser source can be aligned with the fiber, the fiber can be aligned with a rail, a screen position is started at 30 mm, and the diameter of the beam is measured. Then, the screen is moved back 10 mm and the diameter of the beam is again measured. Then, based on the delta Z and the delta d, the NA is calculated.

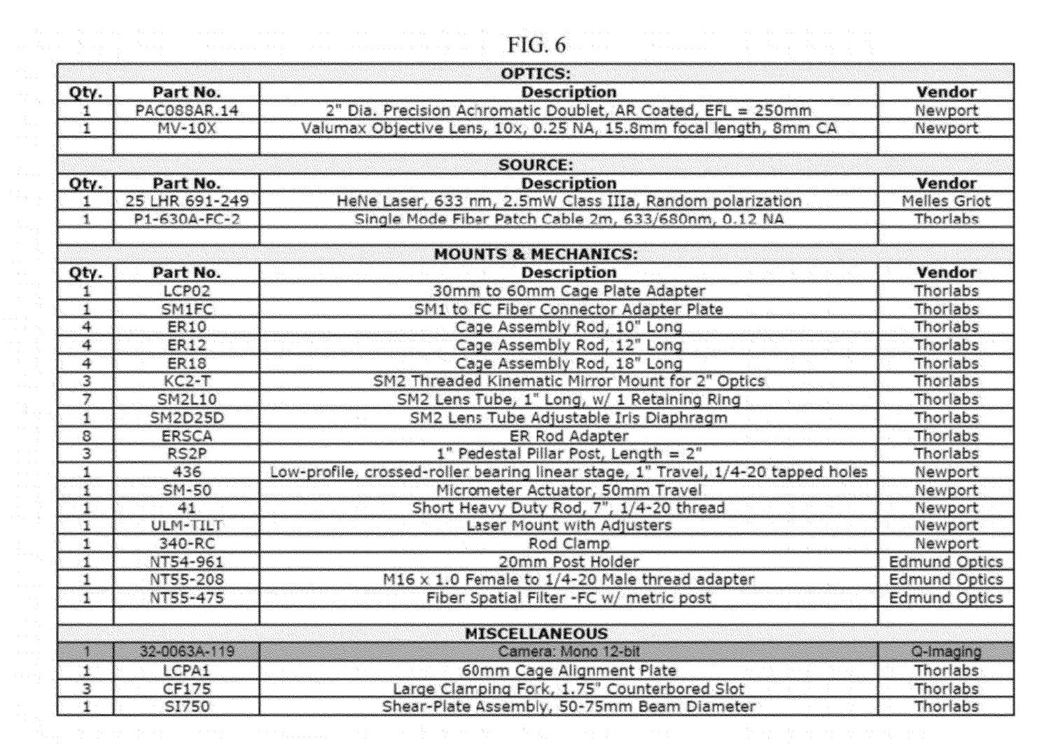

FIG. 6 shows a table of exemplary components that can be used in an optical metrology system according to an exemplary embodiment of the present teachings.

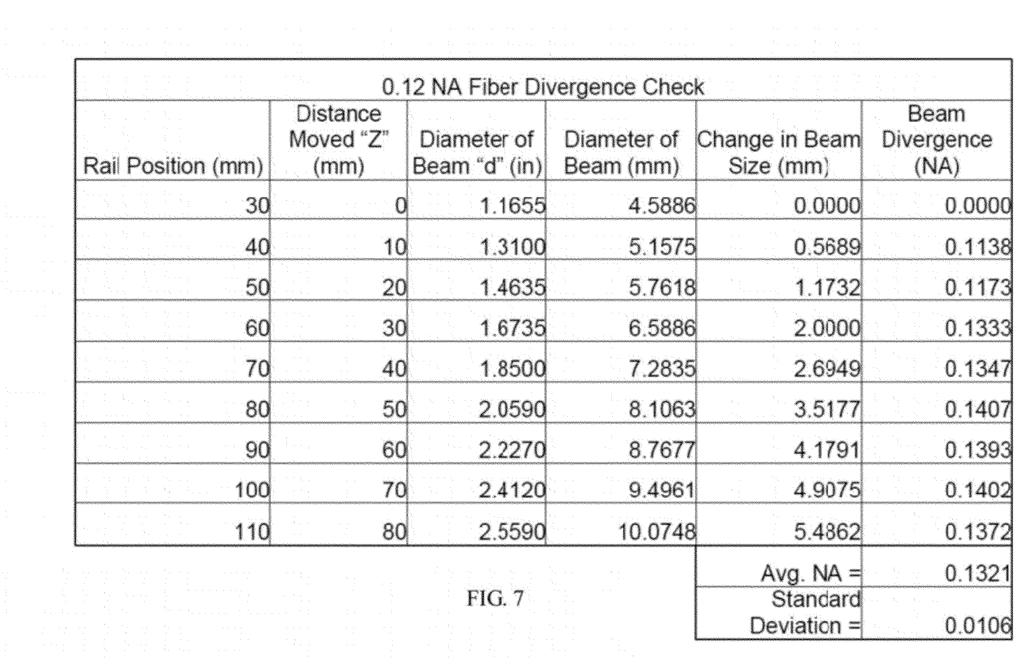

FIG. 7 shows a table providing the fiber divergence for various rail positions, according to an exemplary embodiment of the present teachings.

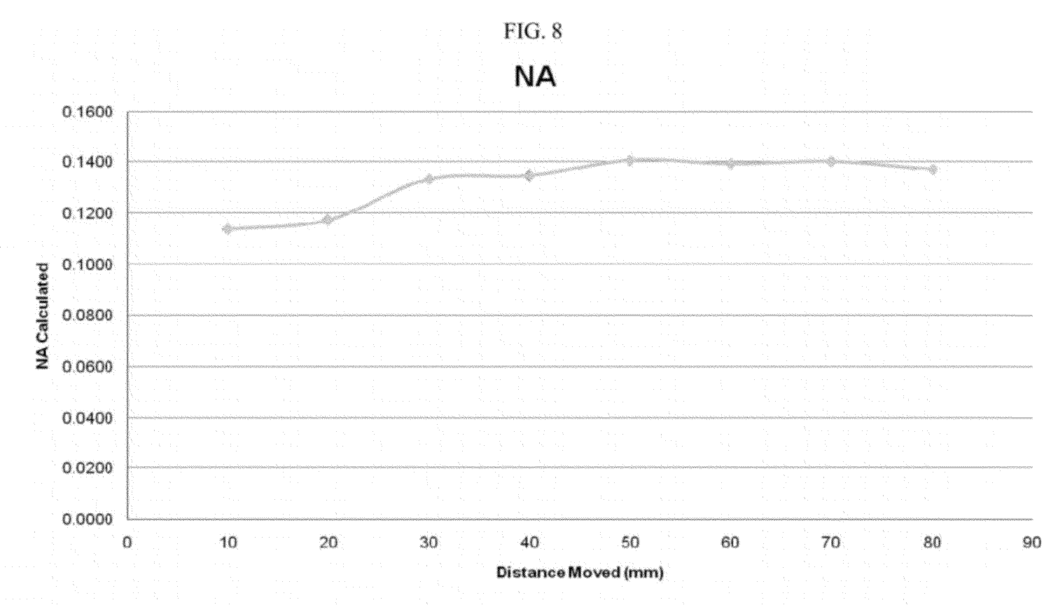

FIG. 8 shows a numerical aperture plot that can be used to determine an appropriate numerical aperture (NA) for an optical metrology system according to an exemplary embodiment of the present teachings.

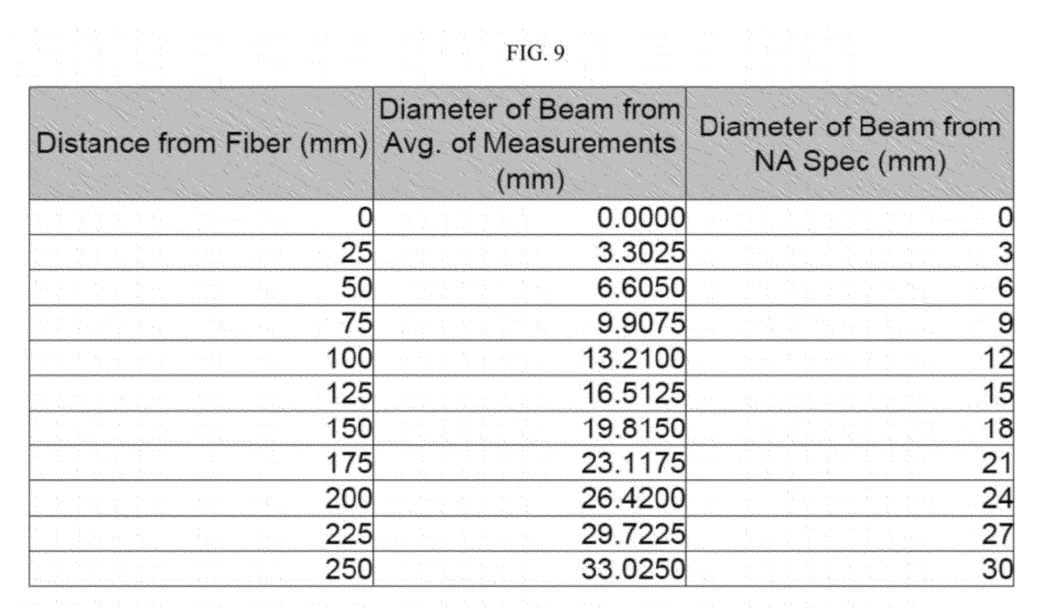

FIG. 9 shows a table depicting distances from the fiber, corresponding beam diameters, and the diameter of the beam resulting from the NA specification associated with various fiber distances achieved according to an exemplary embodiment of the present teachings.

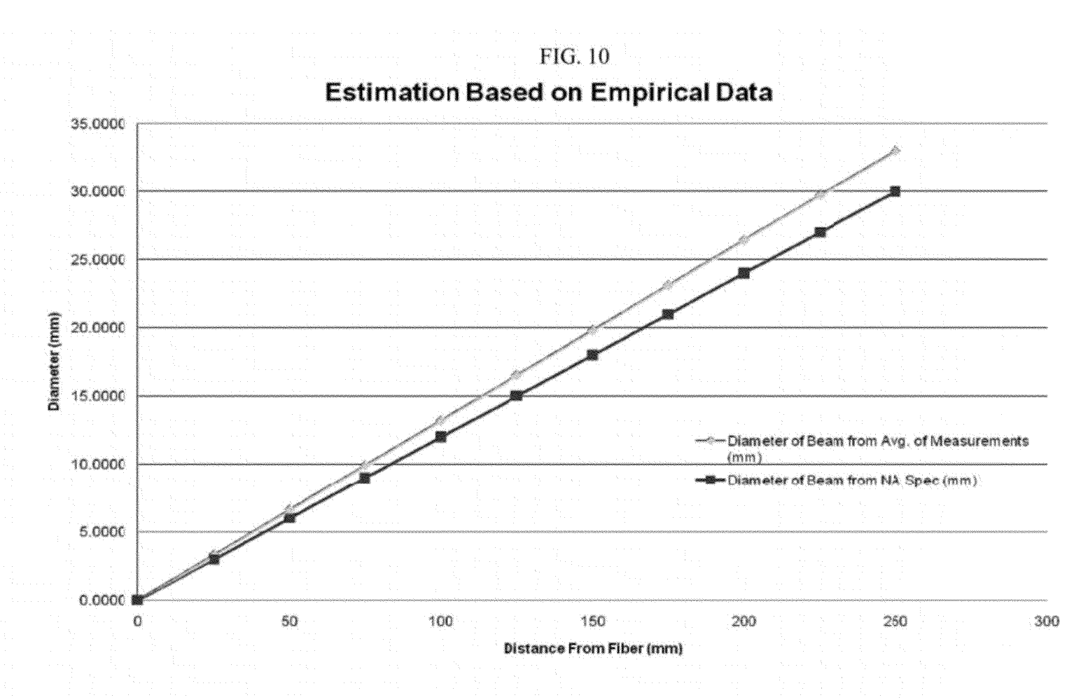

FIG. 10 shows a plot depicting estimated beam diameters and the respective various fiber distances, wherein the estimates were based on empirical data according to various embodiments of a method according to the present teachings.

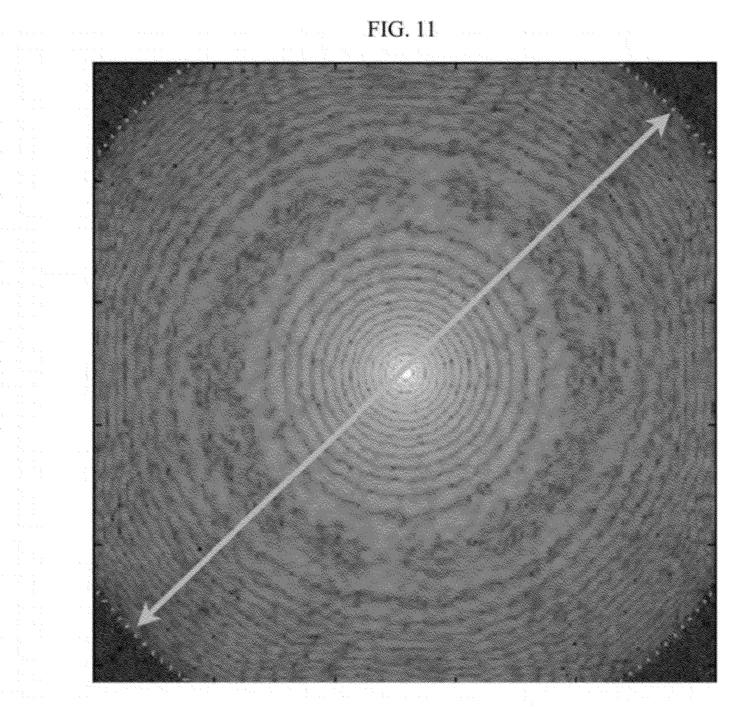

FIG. 11 shows initial phase retrieval (PR) results of an MTF image, according to various embodiments of the present teachings, using a 0.5 inch stop size, an optical cutoff frequency that implies that Q=1.65=λF#/Dx. Therefore, for the image shown, the Focal Ratio is calculated as F#=1.65Dx/λ=(1.65×6.45 μm)/0.6328 μm, which equals about 16.8.

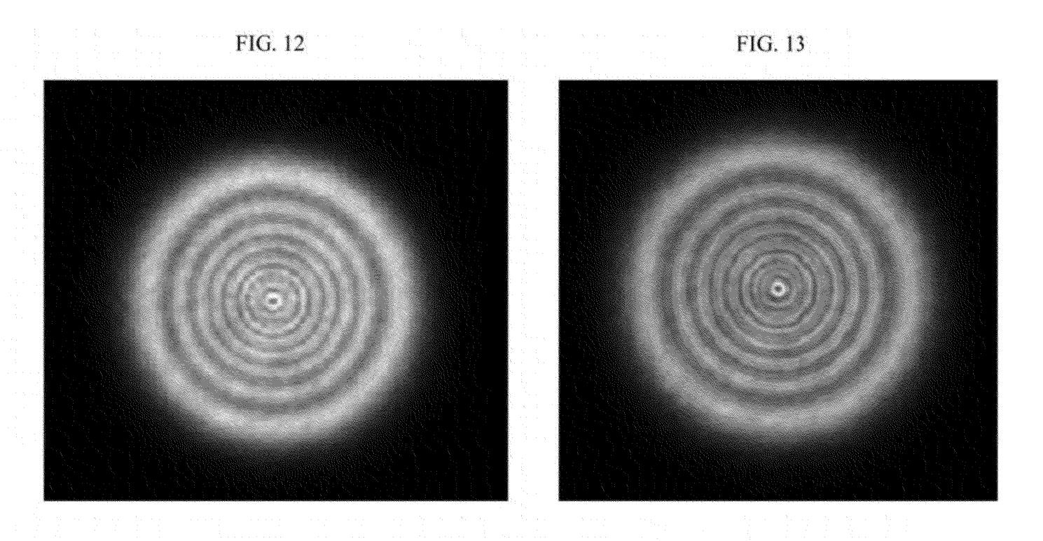

FIGS. 12 and 13 show a comparison between image-based data (shown in FIG. 12), and a Fourier Model resulting from a method according to the present teachings (shown in FIG. 13).

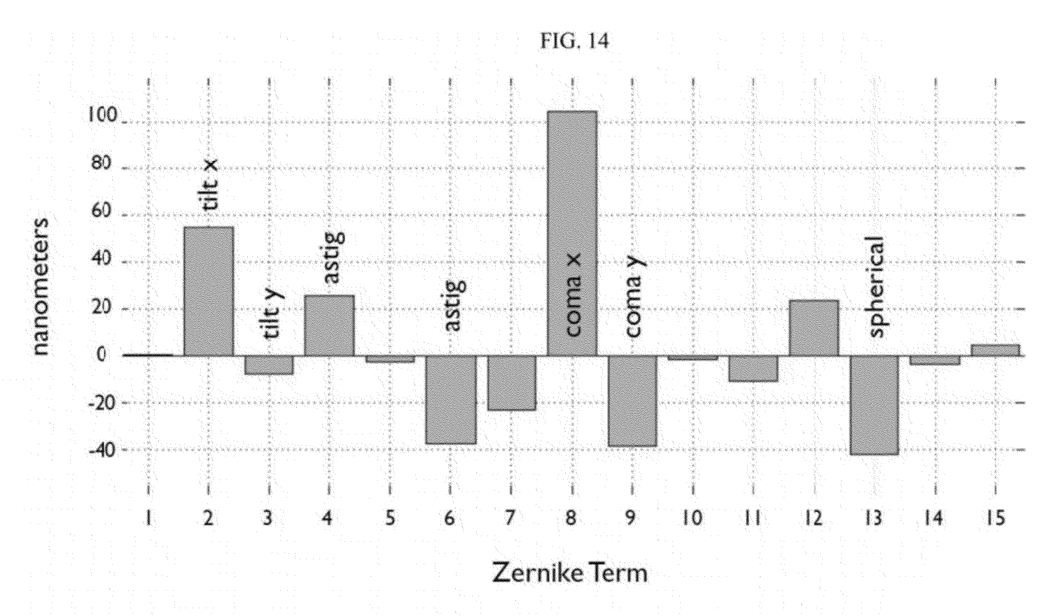

FIG. 14 shows a graph depicting phase retrieval decomposition, according to an exemplary embodiment of the present teachings.

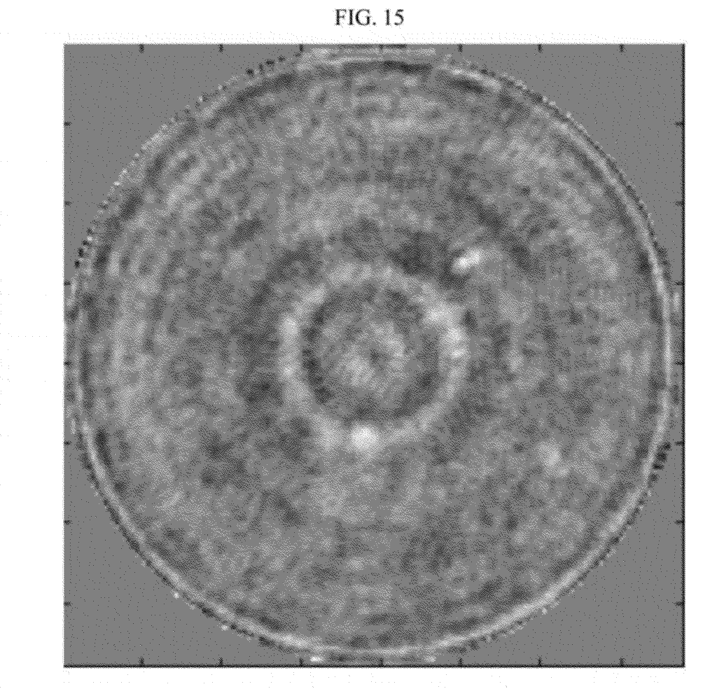

FIG. 15 shows residual surface structure after removal of low-order Zernikes, according to an exemplary embodiment of the present teachings. The lower order Zernikes to be removed can be determined from a graph depicting decomposition such as shown in FIG. 14.

Other embodiments of the present invention will be apparent to those skilled in the art from consideration of the present specification and practice of the present invention disclosed herein. It is intended that the present specification and examples be considered as exemplary only with the true scope and spirit of the invention being indicated by the following claims and equivalents thereof.

What is claimed is:

1. An optical metrology system for assessing impact of optical surface artifacts comprising:
an optical element defining an optical axis and a focal plane;
a laser for producing light;
a fiber coupler coupled to the laser;
a fiber connected to the fiber coupler for transmitting light received from the fiber coupler;
a collimator disposed in a beam path between the fiber and the defocus element, the collimator being adapted to receive light transmitted from the fiber and substantially collimate the light to generate a narrowed input light beam; and
a defocus element disposed between the optical element and the focal plane.

2. The system of claim 1, wherein the defocus element comprises at least one first lens for producing a positive defocus image of a light beam passing through the optical element, and at least one second lens for producing a negative defocus image of the light beam passing through the optical element.

3. The system of claim 1, wherein the at least one second lens comprises a pupil imaging lens.

4. The system of claim 1, wherein the at least one first lens comprises a high powered lens.

5. The system of claim 4, wherein the at least one second lens comprises a lens having a lower power than the at least one first lens.

6. The system of claim 1, wherein the at least one first lens comprises a zinc selenide (ZnSe) lens.

7. The system of claim 1, wherein the at least one first lens comprises a barium fluoride (BaFl) lens.

8. The system of claim 1, wherein the at least one second lens comprises a zinc selenide (ZnSe) lens.

9. The system of claim 1, wherein the at least one second lens comprises a barium fluoride (BaFl) lens.

10. The system of claim 1, wherein the first optical element comprises at least one of a lens, a mirror, an imaging system, a camera, a detector, a laser, and a combination thereof.

11. The system of claim 1, wherein the at least one first lens comprises at least one of a bi-convex lens, a bi-concave lens, a positive meniscus lens, a negative meniscus lens, a plano-convex lens, and a plano-concave lens.

12. The system of claim 1, wherein the at least one second lens comprises at least one of a bi-convex lens, a bi-concave lens, a positive meniscus lens, a negative meniscus lens, a plano-convex lens, and a plano-concave lens.

13. The system of claim 1, wherein the fiber comprises a numerical aperture (NA) of about 0.12.

14. The system of claim 1, wherein the laser comprises a helium neon (HeNe) laser.

15. A method of measuring the numerical aperture of an optical system comprising
an optical element defining an optical axis and a focal plane,
a laser for producing light,
a fiber coupler coupled to the laser,
a fiber connected to the fiber coupler for transmitting light received from the fiber coupler, and
a defocus element disposed between the optical element and the focal plane, the method comprising:
aligning the laser with the fiber;
aligning the fiber with a rail;
setting a first screen position;
measuring the diameter of a beam passing through the defocus element;
setting a second screen position that is moved back relative to the first screen position;
measuring a second diameter of the beam;
determining a DZ from the two measurements;
determining a Dd from the two measurements; and
calculating a numerical aperture based on the DZ and the Dd.

16. The method of claim 15, wherein the first screen position is at about 30 mm from the defocus element.

17. The method of claim 16, wherein the second screen position is at about 40 mm from the defocus element.

18. The method of claim 15, further comprising a collimator disposed in a beam path between the fiber and the defocus element, the collimator adapted to receive light transmitted from the fiber and substantially collimate the light to generate a narrowed input light beam.

19. The method of claim 15, further comprising printing or displaying a value for the calculated numerical aperture.
